(19) United States
(12) Patent Application Publication
(10) Pub. No.: US 2026/0049711 A1
(43) Pub. Date: Feb. 19, 2026

(54) POOL WATER SCUPPER LIGHTING SYSTEM

(71) Applicant: BELLSON ELECTRIC PTY LTD, Caringbah NSW (AU)

(72) Inventor: David John Sanson, Taren Point NSW (AU)

(21) Appl. No.: 19/301,692

(22) Filed: Aug. 15, 2025

Related U.S. Application Data
(60) Provisional application No. 63/684,256, filed on Aug. 16, 2024.

(51) Int. Cl. F21V 33/00; F21W 131/10

(52) U.S. Cl. CPC F21V 33/006; F21W 2131/10

(57) ABSTRACT

A pool water scupper lighting system includes a scupper body and a waterspout extending from the scupper body. At least one light source is positioned at least partially in the waterspout. At least one light source is positioned to direct a quantity of light into the path for water.

### CROSS REFERENCE TO RELATED APPLICATION

This application claims benefit of U.S. Provisional Application Ser. No. 63/684,256 entitled, “POOL WATER SCUPPER LIGHTING SYSTEM” filed Aug. 16, 2024, the entire disclosure of which is incorporated herein by reference.

### FIELD OF THE DISCLOSURE

The present disclosure is generally related to water feature lighting and more particularly is related to a pool water scupper lighting system.

### BACKGROUND OF THE DISCLOSURE

It is common for swimming pools and water features to use scuppers to move water from one area of the pool to another, to cool the water and improve chlorine retention, and to enhance the visual and auditory appeal of water flowing into the pool or water feature. For instance, within the swimming pool industry, the water flow of a scupper can be used to provide the soothing sound of flowing water into the pool. The scupper may be connected to other water feature equipment, for example, valve actuators to open and shut various valves, pool pumps to create a flow of water through a scupper, chlorinators and sanitizers, lighting systems, and other equipment that is commonly seen in a pool, such as swim jets, etc. However, typically pool or water feature scuppers 10 are simplistic, and may be little more than a water pipe connected to an open box with a lip 4 to provide a flow path for the water 2, such as shown in FIG. 1. In low light situations, the appeal of the flow of water through the scupper is often limited to the auditory senses.

Thus, a heretofore unaddressed need exists in the industry to address the aforementioned deficiencies and inadequacies.

### SUMMARY OF THE DISCLOSURE

Embodiments of the present disclosure provide a pool water scupper lighting system. Briefly described, in architecture, one embodiment of the system, among others, can be implemented as follows. A waterspout extends from a scupper body. At least one light source is positioned at least partially in the waterspout and located proximate to a path for water. The at least one light source is positioned to direct a quantity of light into the path for water.

Another aspect of the present disclosure provides a lighting system for a pool scupper. Briefly described, in architecture, one embodiment of the system, among others, can be implemented as follows. An aqueduct is connectable to a water pipe adapter.

In another aspect, at least one light source is positioned at least partially in the aqueduct and located proximate to a path for water.

In yet another aspect, the path for water extends to a terminating edge of the aqueduct from the water pipe adapter.

In yet another aspect, the at least one light source is positioned to direct a quantity of light into the path for water.

A further example of the present disclosure provides for a device to light a pool water scupper. The device includes a lighting adapter electrically connectable to a light source.

In another aspect, a plate is attachable to an aqueduct. A water pipe adapter connects to the plate at a first location, and the lighting adapter connects to the plate at a second location. When the plate is attached to the aqueduct, a substantially watertight seal is formed between the plate and the aqueduct.

Yet another aspect includes a path for water from the plate through the aqueduct and over a terminating edge of the aqueduct.

Still another aspect is a support positionable within the aqueduct and connectable to the plate. The support at least partially surrounds the light source along at least a portion of the path for water within the aqueduct.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a diagrammatical illustration of a pool water scupper system, in accordance with the prior art.

FIGS. 2A-2B are exploded view illustrations of a pool water scupper lighting system, and an exploded view illustration of an LED strip and bracket, respectively, in accordance with embodiments of the present disclosure.

FIGS. 3A-3B are side view and top view illustrations, respectively, of a pool water scupper lighting system, in accordance with embodiments of the present disclosure.

FIGS. 4A-4B are front perspective and front view illustrations, respectively, of a pool water scupper lighting system, in accordance with embodiments of the present disclosure.

FIGS. 5A-5B are side cross section view and exploded side view illustrations of a pool water scupper lighting system, in accordance with embodiments of the present disclosure.

FIGS. 6A-6B are a second side view and bottom view illustrations of a pool water scupper lighting system, in accordance with embodiments of the present disclosure.

FIG. 7 is a front view on angle illustration of a pool water scupper lighting system, in accordance with embodiments of the present disclosure.

FIG. 8 is a diagrammatical illustration of an installed pool water scupper lighting system, in accordance with embodiments of the present disclosure.

FIGS. 9-10 are side view and cross-sectional side view illustrations, respectively, of a lighting system for a pool scupper, in accordance with embodiments of the present disclosure.

FIGS. 11 and 12 are exploded view illustrations of a lighting system for a pool scupper, in accordance with embodiments of the present disclosure.

FIGS. 13A-14C are top view, side view, and front angle view illustrations of a lighting system for a pool scupper, respectively, in accordance with embodiments of the present disclosure.

FIG. 15 is a back view illustration of a lighting system for a pool scupper, in accordance with embodiments of the present disclosure.

FIGS. 16A-16B are front view illustrations of a lighting system for a pool scupper, in accordance with embodiments of the present disclosure.

FIG. 17 is an exploded view illustration of a device to light a pool water scupper, in accordance with embodiments of the present disclosure.

FIG. 18 is a diagrammatical flowchart illustrating a method of lighting a pool water scupper, in accordance with embodiments of the present disclosure.

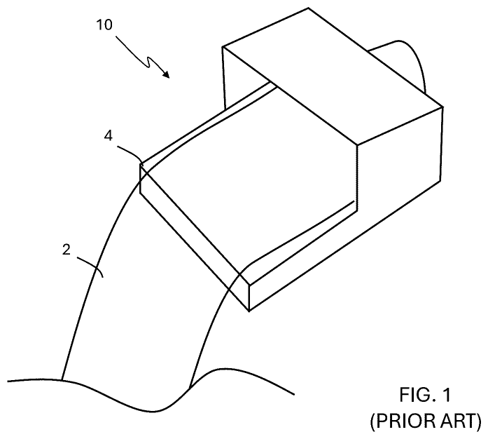

### DETAILED DESCRIPTION

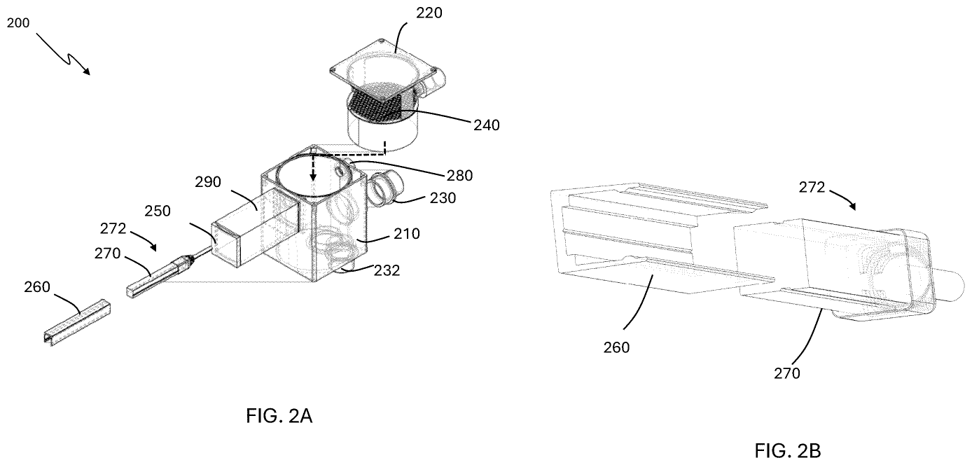

To overcome the shortcomings of the conventional water scupper system, a system and method for water scupper lighting system is disclosed. FIG. 2A is an exploded view of a diagrammatical illustration of a pool water scupper lighting system 200, in accordance with embodiments of the present disclosure. In one example of system 200, which may be referred to herein as system 200, a scupper body 210 may have a waterspout 290 extending from the scupper body 210.

Additionally, at least one light source may be positioned at least partially in the waterspout and located proximate to a path for water. The at least one light source may be positioned to direct a quantity of light into the path for water.

In another example, the pool water scupper lighting system 200 has a scupper body 210 to which numerous components may be attached. For example, a top cover 220 of the system 200 may be removably attachable to the scupper body 210 to enable access to an interior of the scupper body 210, such as for installation, service, and maintenance of the scupper components. The top cover 220 and scupper body 210 may be in any shape, such as round, square, ovoid, or rectangular, as shown in FIG. 2A. The top cover 220 may be additionally attached to other scupper components, such as a filter 240, to enable ease of maintenance and repair. The scupper body 210 may have multiple inlets and openings to allow ingress and egress of water, electrical connections, or installations of other components.

A first water pipe adapter 230 may provide an inlet path through which water may flow into the scupper body 210. First water pipe adapter 230 may connect to a water conduit to receive water. Water may drain through a second water pipe adapter 232. A filter 240 may be positionable within an interior space of the scupper body 210 between the first water pipe adapter 230 and a waterspout 290, such that water entering the first water pipe adapter 230 flows through filter 240 and exits scupper body 210 through waterspout 290. The filter 240 may filter the water, or it may alter the path of the water, such as by converting turbulent flow of the water into a laminar flow, or by directing it to the waterspout 290.

In one example, a filter 240 may be located within the scupper body 210. A laminar flow of water may extend from the filter 240 along at least a portion of the path for water.

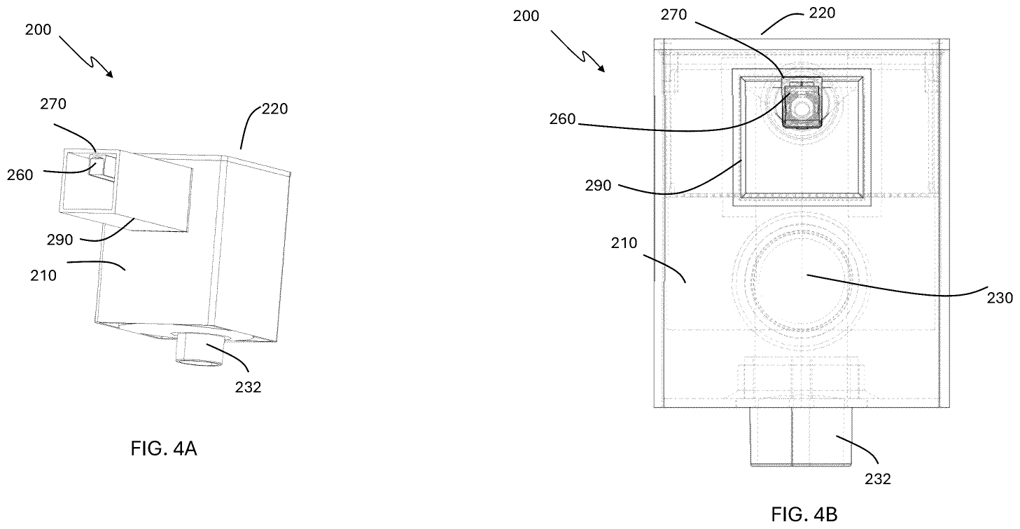

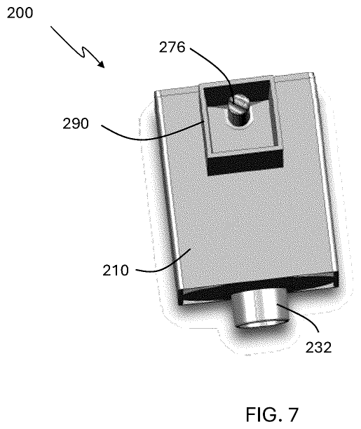

The waterspout 290 may be connected to the scupper body 210 and extend outwards therefrom, such that a terminating end of waterspout 290 is positioned removed from the scupper body 210, and ideally, vertically above a pool or similar body of water. The waterspout may be in any shape, including round, square, ovoid, or rectangular as shown in FIGS. 4A, 4B, and 7. The waterspout 290 may be positionable at a downward angle to direct the flow of the water into the pool or similar body of water and away from the scupper body 210, to further enhance the visual and auditory appeal of the scupper.

In another example, a mount 260 may be affixed within the scupper body 210 and connectable between scupper body 210 and the at least one light source 272. Waterspout 290 may have a mount 260 within an interior thereof, whereby mount 260 may hold at least one light source 272 in a position above or proximate to the path. Mount 260 may extend through the spout plug 250. Light source 272 may be connected to mount 260, such that mount 260 retains light source 272 in the position within waterspout 290. It may also be possible for mount 260 to also provide an electrical connection to light source 272, such as when mount 260 includes an integrated electrical connection, whereby light source 272 is both physically held by mount 260 and electrically powered.

In yet another example, a spout plug 250 may be positioned proximate to an interface between the scupper body 210 and the waterspout 290. Mount 260 may extend through the spout plug 250.

A spout plug 250 may be positioned near or proximate to an interface between waterspout 290 and scupper body 210. Spout plug 250 may provide additional physical support for at least one light source 272, may aesthetically block a visual path into scupper body 210, and may enhance safety by preventing a child or animal from penetrating the body and interacting with the components of the scupper while being positionable to allow water to flow beneath, around, or through it. Spout plug 250 may seal the scupper when the water feature is not in use, such as during winter.

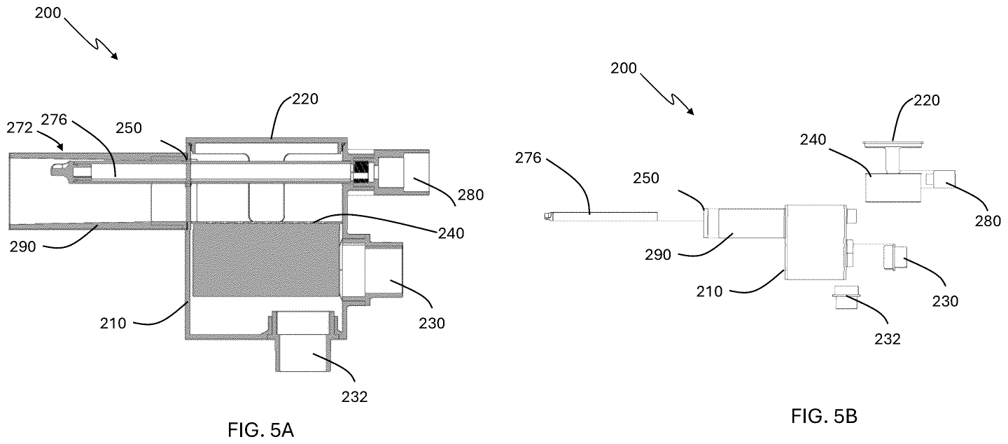

Light source 272 may be any type of light source, including a LED strip 270, a light pipe 276 (FIGS. 5A-5B), or a fiber optic, or a combination. In one example, at least one light source 272 may be at least one of a light pipe or an LED strip.

FIG. 2B shows an exploded view of one example of light source 272, including an LED strip 270 and mount 260. Light source 272 may be slidably attachable to the mount 260, however other methods of positioning at least one light source 272 are also part of this disclosure, including a clip, a friction fit, a post, a screwable attachment within or through the scupper body 210 or the waterspout 290, and a suspension mechanism from the top of the waterspout 290 or from the top cover 220. Although shown substantially centrally positioned, light source 272 may also be positionable proximate to a side of the scupper and proximate to a corner.

In another example, a power source may be electrically connectable to the at least one light source 272. The at least one light source may be electrically isolated from the path for water for safety, ease of maintenance, and ease of installation.

In yet another example, a lighting system adapter 280 may be coupled to the scupper body 210. The lighting system adapter 280 may electrically isolate the power source from the path of water.

Light source 272 may operate at a low voltage (24V DC). In operation, light source 272 may provide diffused illumination that may refract or reflect into the water, providing additional lighting effects. Mount 260 or light source 272 may electrically connect to power through a power conduit that is electrically isolated from the water by a lighting system adapter 280 connected to the scupper body 210. The power conduit may be any size, including standard half inch or three-quarter inch electrical conduit, and is not limited to standard sizes. The power conduit may electrically connect to lighting system adapter 280.

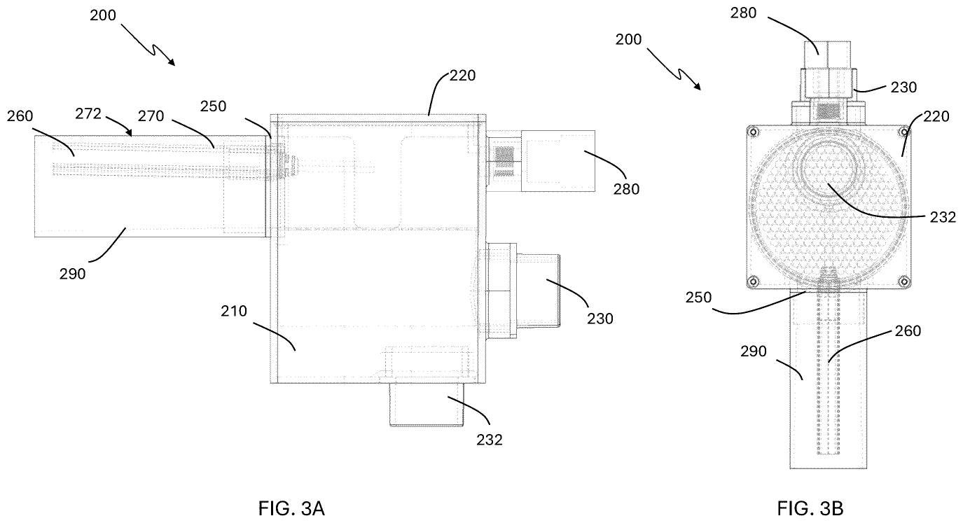

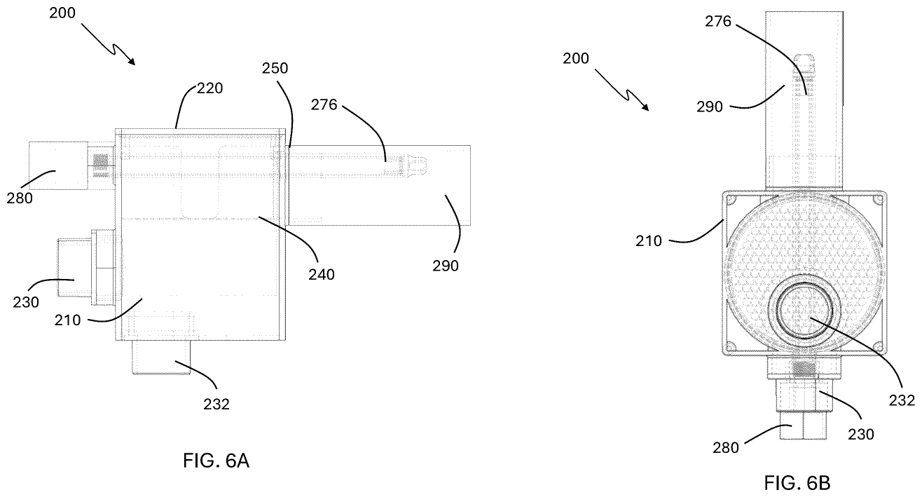

FIG. 3A through FIG. 7 each show embodiments of the present disclosure. FIGS. 3A and 3B show a side view and top view, respectively, of an assembled pool water scupper lighting system 200. FIGS. 4A and 4B show a front perspective view and a front view, respectively, of pool water scupper lighting system 200. FIG. 4A shows the LED light strip 270 and mount 260 positioned within and extending into the waterspout 290. FIGS. 5A and 5B show side views of a cross section and an exploded view, respectively, of an example of pool water scupper lighting system 200, with light pipe 276 serving as the light source 272. In the example shown in FIG. 5A, the light pipe is threadedly attached to the lighting system adapter 280, but may also form a friction fit with the lighting system adapter 280. FIGS. 6A and 6B show a side view and bottom view, respectively, of pool water scupper lighting system 200 in accordance with an embodiment of the present disclosure.

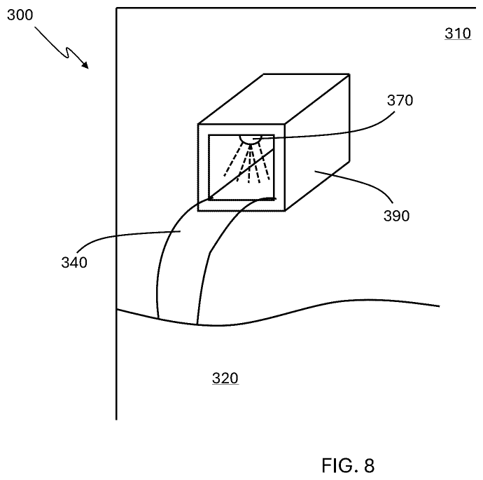

FIG. 7 shows an example of the front view of pool water scupper lighting system 200, on an angle to depict the light pipe 276 within the waterspout 290. FIG. 8 is a diagrammatical illustration of pool water scupper with lighting system 300 installed in a wall of a water feature such as a pool, fountain, or pond in accordance with an embodiment of the current disclosure. System 300 is installed proximate to a wall 310 of a water feature. In this example, the waterspout 390 of system 300 extends from the wall 310 over the water feature 320. A light source 370 is positioned inside the waterspout 390. When powered on, the light source 370 provides illumination from within the waterspout 390, enhancing the visual attractiveness of system 300, and enhancing safety. In operation, the water 340 flows from the waterspout 390 into the water in the water feature, enhancing the auditory appeal of the water feature in addition to the visual appeal provided by the lighting within the waterspout 390.

A driver may control the light source 272 color, speed of color changes, brightness, and other programmable modes. The driver may additionally control the flow of water through the water scupper. The light source 272 may be synchronized to operate with or independently of other lighting systems. The flow of water through the scupper may be synchronized or independent of other water systems. The light source 272 may be electrically connected to and controlled by a networked computerized device, a remote, wireless controller, or through an app, such as on a tablet or smartphone. The driver may incorporate timers to control the power to the light source 272, illuminating a flow of water flowing through the scupper, drawing attention to and enhancing the visual appeal of the scupper and providing illumination for safety.

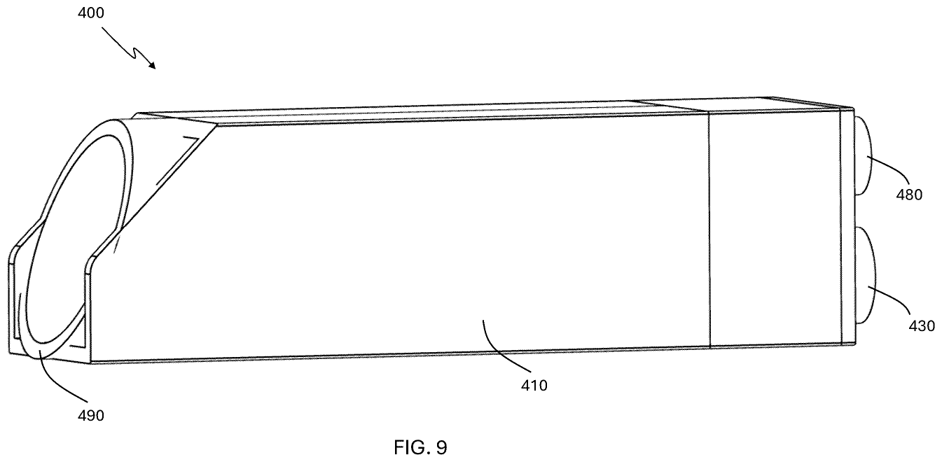

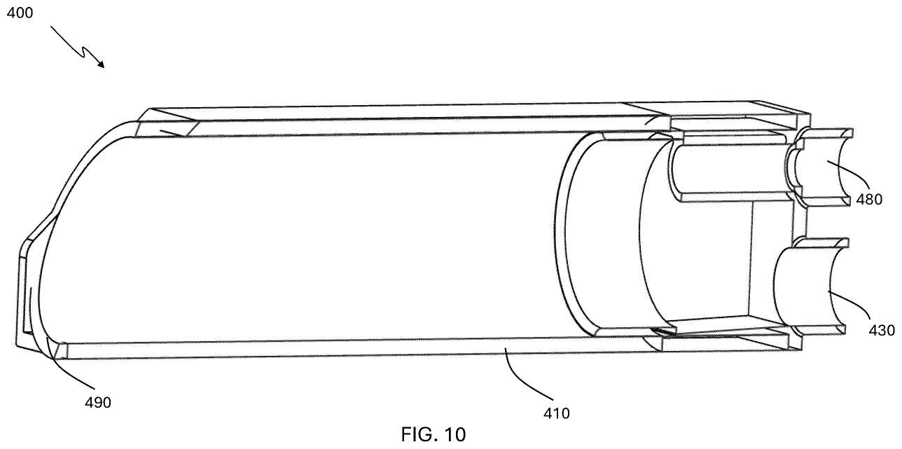

FIGS. 9-10 are side view and cross-sectional side view illustrations, respectively, of a lighting system for a pool scupper 400, in accordance with embodiments of the present disclosure. As shown, the lighting system for a pool scupper 400 has a design which may be different from that depicted in FIGS. 2A-6, in that, the aqueduct 410 is elongated and may not have a removable top or top cover. At a rear side of the aqueduct 410, the water pipe adapter 430 and the lighting system adapter 480 are provided for allowing a flow of water, or the electrical conductors, respectively, to be introduced into the aqueduct 410. As shown in FIG. 10, the lighting system adapter 480 may be positioned near a top portion of the aqueduct 410 such that the lighting device (not shown) can be located in a position above the floor of the aqueduct 410 on which a flow of water moves. In this position, the lighting device may illuminate the flow of water through the aqueduct 410 and also provide illumination to the front opening of the aqueduct 410. In this design, the front opening of the aqueduct 410 may be angled thereby providing a better ability to view the interior of the aqueduct 410 and visually identify the light therein. The design of FIGS. 9-10 may include any of the other features discussed relative to FIGS. 2A-6, all of which are considered within the scope of the present disclosure. For example, FIG. 9 may show a rounded shape positioned within a rectangular aqueduct 410 and in-line with the water pipe adapter 430 and the terminating edge 490 of aqueduct 410. However, aqueduct 410 may also have a rounded shape or any shape capable of conducting water from the water pipe adapter 430 over a terminating edge 490 and can accommodate a lighting device above the floor of the aqueduct 410.

One benefit of the design of FIGS. 9-10 is it provides a more in-line structure which focuses on the electrical and water entry points at the back of aqueduct 410. Conventional devices do not utilize structures with these connection points along the back of the aqueduct 410. Having these connection points in this location allows the light to be mounted inside the aqueduct 410 of the scupper and the cable to be run from out the back, such that the electrical cable providing power to the light always remains above the waterline of the pool. This design, therefore, limits risk with electric-to-water contact, allows for easier replacement or repair of the electrical cable, and can provide benefits to installing the scupper lighting system 400 in locations where space is limited, such as along a wall with other pool equipment limiting the available space for electrical and fluid connections.

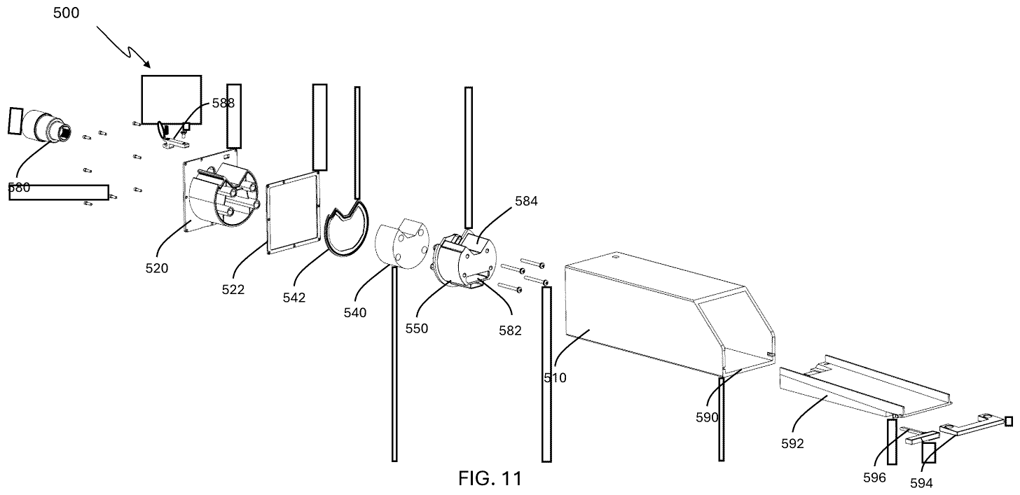

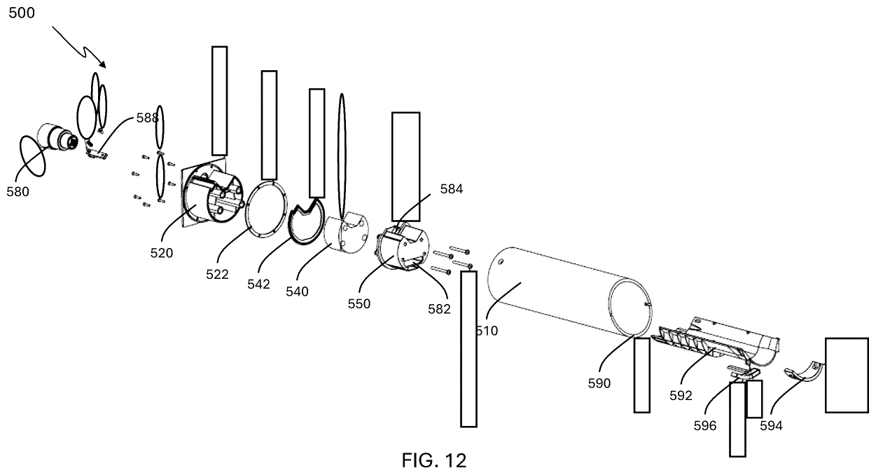

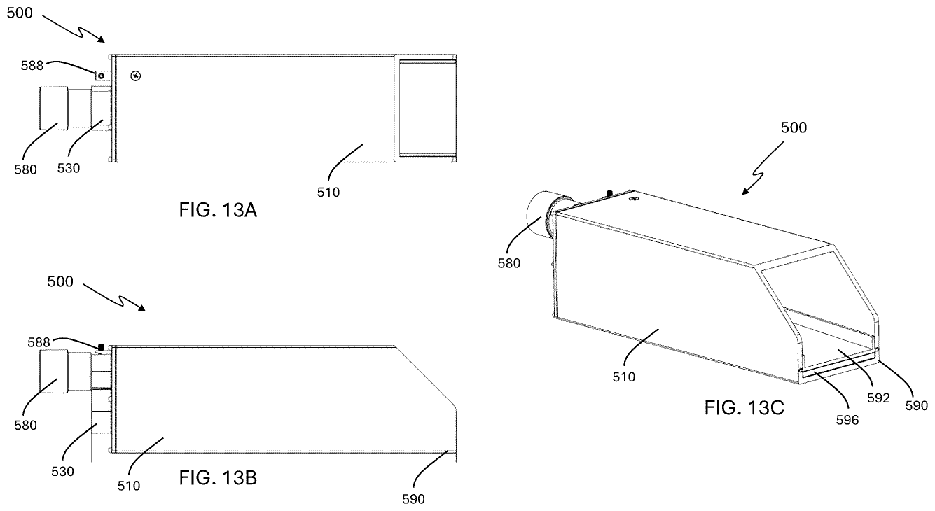

FIGS. 11 and 12 are exploded view illustrations of lighting system for a pool scupper 500 in accordance with embodiments of the present disclosure. In one example, the lighting system 500 may include an aqueduct 510 connectable to a water pipe adapter 530 (FIGS. 13A-15).

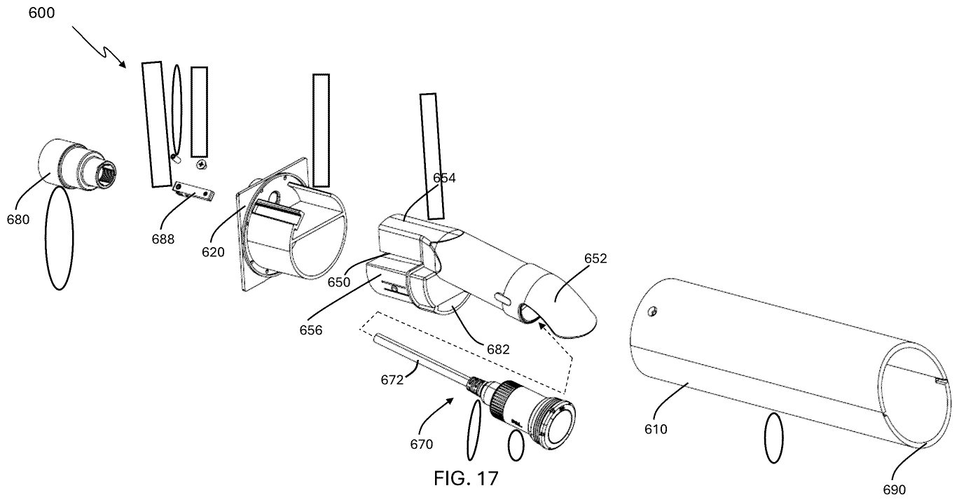

Additionally, at least one light source, such as light source 670 in FIG. 17, may be positioned at least partially within aqueduct 510 and located proximate to a path for water. The path for water may extend to terminating edge 590 of aqueduct 510 from water pipe adapter 530. At least one light source 570 may be positioned to direct a quantity of light into the path for water.

As shown, the lighting system for a pool scupper 500 has a design which may be different from that depicted in FIGS. 2A-10, in that the aqueduct 510 may be elongated and a water filter 540 may be incorporated in-line between the water entry and the water exit.

In another example, a water filter 540 may be positionable in-line between the water pipe adapter 530 and the terminating edge 590 of the aqueduct 510. Water filter 540 may be a pressurized water filter system. Water filter 540 may slow the flow of water or promote a laminar flow of water, or an even sheet of water. This may have the benefit of reducing splashing and water noise when the flow of water extends over a terminating edge 590 of aqueduct 510, enhancing a peaceful aesthetic for the water feature. Aqueduct 510 may be rectangular in cross sectional shape, as shown in FIG. 11, or may be rounded in cross-sectional shape, as in FIG. 12, as examples of aqueduct 510 shapes. FIGS. 11 and 12 may show like components with the same number, which may not be separately described for each of FIGS. 11-16B for brevity of disclosure.

In another example, plate 520 may be connectable to aqueduct 510. A substantially watertight seal may be formed when the plate 520 is connected to aqueduct 510. A filter box 550 may be connectable to plate 510. Water filter 540 may be positionable within filter box 550. Lighting system 500 may include a grounding device 588 attachable to a plate 520 proximate to the lighting adapter 580.

In an example, lighting adapter 580 may be connectable to at least one light source 570 through the plate 520. Plate 520 may connect to lighting adapter 580 and water pipe adapter 530. Aqueduct 510 may be affixable to plate 520 with threaded fasteners, for example, though other fasteners may also affix plate 520 to aqueduct 510. Aqueduct 510 may also be attached to plate 520 permanently, for example, by welding or molding in a single piece. However, a separation of plate 520 and aqueduct 510 may provide advantages in manufacturing, installation, or servicing.

A first gasket 522 may be positionable between the plate 520 and the aqueduct 510. First gasket 522 may form a substantially watertight seal between plate 520 and aqueduct 510. A second gasket 542 may be positionable between the plate 520 and the water filter 540. Second gasket 542 may form a substantially watertight seal between filter box 550 and plate 520. Filter box 550 may take the place of spout plug 250. Water filter 540 may be shaped to accommodate a light source 670 (see FIG. 17). Light source 670 may extend from the lighting adapter 580 and into the aqueduct 510. The water filter 540 may be positionable within filter box 550. Filter box 550 may connect to plate 520 through water filter 540. Plate 520 may have attachment points shaped to extend into aqueduct 510 and connectable to filter box 550. Filter box 550 may have a water opening 582 through which water may flow and a lighting opening 584 through which the lighting device may extend into the aqueduct 510. Water filter 540 may be between the water opening 582 and the water pipe adapter 530.

At least one of plate 520, water filter 540, second gasket 542, or filter box 550 may be shaped to provide physical support to lighting device 570 and may support lighting device 570 along the path of the flow of water within aqueduct 510. The lighting opening 584 may allow for separation of the power supply to the light device 570 and the path for a flow of water, electrically isolating the lighting device 570 from the water path.

In another example, ramp 592 may extend from filter box 550 to terminating edge 590 of aqueduct 510. A ramp 592 may extend within aqueduct 510 from water opening 582 to terminating edge 590 of aqueduct 510.

In an example, a light strip 596 may be positioned proximate to terminating edge 590 of aqueduct 510. The ramp 592 may isolate the electrical power supply to the light strip 596 from water. Ramp 592 may be slidably positionable within aqueduct 510 and may make a frictional fit attachment to aqueduct 510. The ramp 592 may accommodate a lens 594 proximate to the terminating edge 590.

In another example, a lens 594 may be between light strip 596 and the path for water. Lens 594 may direct a quantity of light from light strip 596 into the path of water. A light strip 596 may be positioned beneath the lens 594. Light strip 596 may be incorporated beneath a terminating edge 590 of the aqueduct 510. Light strip 596 may create a dramatic edge-lighting effect that illuminates water as it spills over the terminating edge 590 of aqueduct 510.

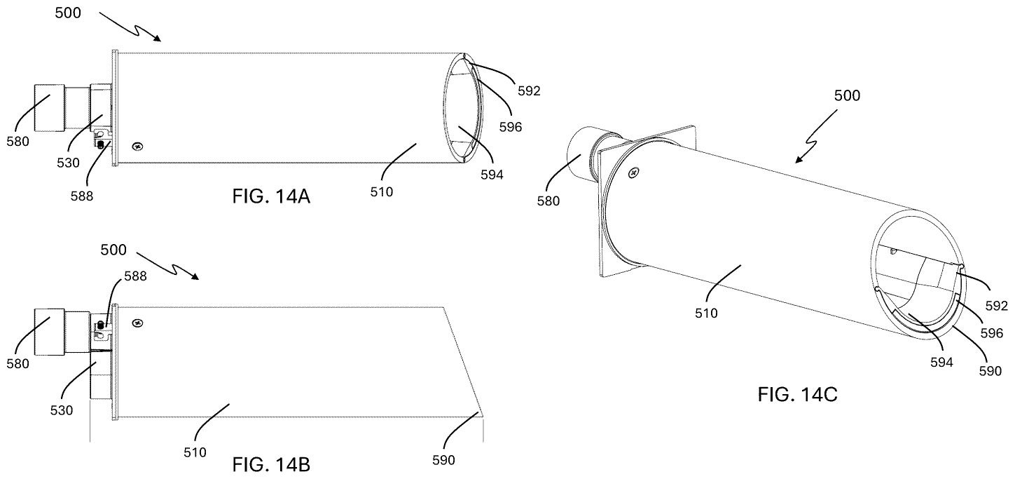

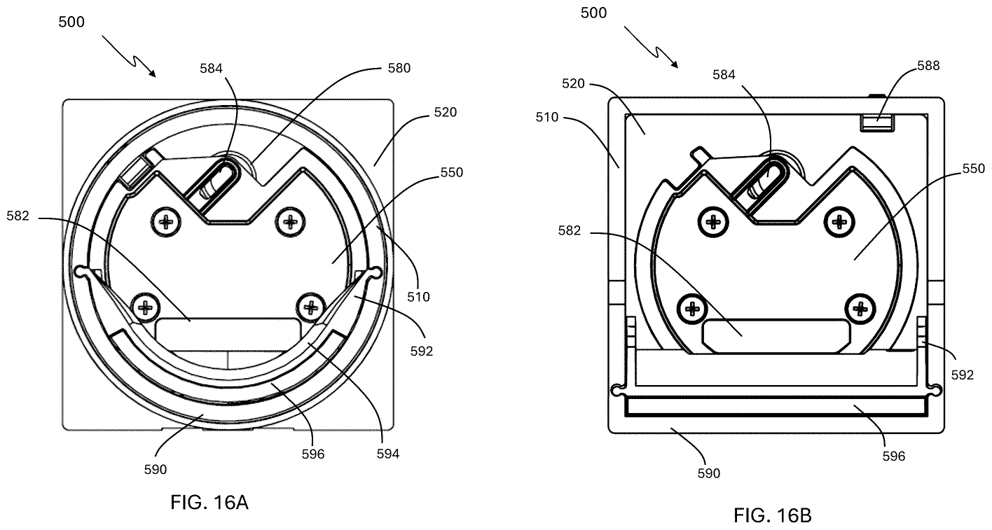

FIGS. 13A-14C are top view (FIGS. 13A and 14A), side view (FIGS. 13B and 14B), and front angle view (FIGS. 13C and 14C) illustrations of a lighting system for a pool scupper 500 for rectangular aqueduct 510 or rounded aqueduct 510, respectively, in accordance with embodiments of the present disclosure. FIG. 13C may show a ramp 592 without a lens 594 positioned between light strip 596 and ramp 592. FIGS. 14C and 16A illustrate ramp 592, lens 594, and light strip 596 may be rounded to accommodate aqueduct 510 with a rounded shape. FIG. 13C shows lighting system for a pool scupper 500 may include light strip 596 without lens 594, for example when ramp 592 extends through aqueduct 510 and ends proximate to terminating edge 590. Many of the same components as described for FIGS. 11 and 12 are present in FIGS. 13A-14C and are not repeated here for brevity of disclosure.

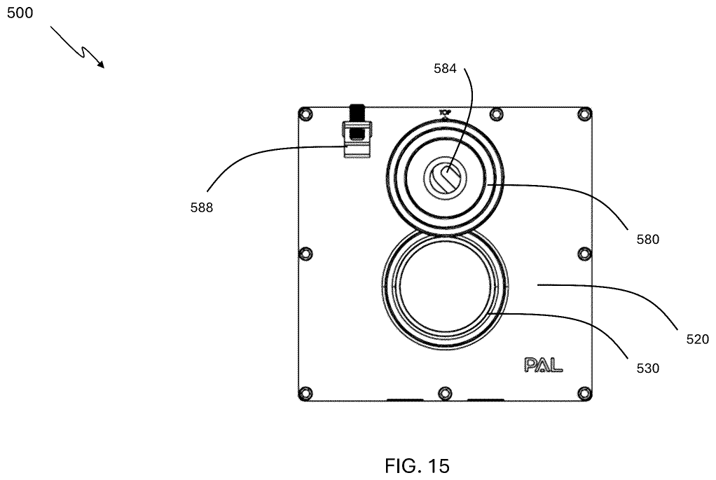

FIG. 15 is a back view illustration of lighting system for a pool scupper 500 in accordance with embodiments of the present disclosure. As shown in FIG. 15, plate 520 may be shaped to accommodate both lighting adapter 580 and water pipe adapter 530. Grounding device 588 may be affixed proximate to lighting adapter 580. Grounding device 588 may be shaped to accommodate a wire from a power source to the light source 570 (also refer to, e.g., FIGS. 14A and 14B). Lighting opening 584 in filter box 550 may be visible through the accommodation for lighting adapter 580. Grounding device 588 may electrically connect to light source 570 and may provide an electrical ground for light source 570.

FIGS. 16A-16B are front view illustrations of a lighting system for a pool scupper 500 in accordance with embodiments of the present disclosure. As shown in FIG. 16A aqueduct 510 may have a rounded shape. FIG. 16B shows that aqueduct 510 may have a rectangular shape. When aqueduct 510 has a rounded shape, ramp 592, lens 594, and light strip 596 may also be rounded to fit therein. Both FIGS. 16A and 16B show that when the path of water flows over terminating edge 590, light strip 596 may be positioned to emit a quantity of light into the water. Light strip 596 may provide a dramatic edge-lighting effect to the water as it spills over the terminating edge 590, further enhancing the aesthetic effect. As shown in FIGS. 16A and 16B, the path for the flow of water may be physically separated from the light 570 source. In an example, the light source 570 may be positioned above the path of water. Filter box 550 may be shaped to accommodate light source 570, which may extend through lighting opening 584 in the filter box 550. Filter box 550 may be affixed within aqueduct 510 to plate 520, for example, with threaded fasteners, and may be shaped to physically support light source within aqueduct 510.

FIG. 17 is an exploded view illustration of a device to light a pool water scupper 600 in accordance with embodiments of the present disclosure. In an example, a lighting adapter 680 may be electrically connectable to a light source 670.

A plate 620 may be attachable to an aqueduct 610. A water pipe adapter (not shown in FIG. 17, refer to, e.g., FIGS. 13-16) connects to plate 620 at a first location, and lighting adapter 680 connects to the plate 620 at a second location. When plate 620 is attached to the aqueduct 610, a substantially watertight seal is formed between the plate 620 and the aqueduct 610.

A path for water may extend from plate 620 through aqueduct 610 and over a terminating edge 690 of the aqueduct 610.

A support 650 may be positionable within the aqueduct 610 and connectable to plate 620, wherein support 650 at least partially surrounds light source 670, when the light source 670 is located within the support 650, along at least a portion of the path for water within the aqueduct 610. For instance, the electrical cable 672 of light source 670 may be inserted through the support 650, and can extend through plate 620 and into lighting adapter 680, while the body of the light source 670 can be positioned generally in the support 650 body. In FIG. 17, the light source 670 is depicted outside of the support 650.

In another example, grounding device 688 may be affixable to plate 620 and electrically connectable to light source 670.

As shown in FIG. 17, lighting adapter 680 may be shaped to receive light source 670. Lighting adapter 680 may otherwise electrically connect to light source 670. Plate 620 may accommodate lighting adapter 680. Plate 620 may also be shaped to receive support 650. Support 650 may be positionable within aqueduct 610.

In another example, support 650 may be slidably receivable by plate 620.

In yet another example, support 650 may include a light chamber 654 and a water chamber 656. The light chamber 654 may extend from plate 620 into aqueduct 610. Support 650 may physically support light source 670 and may electrically isolate light source 670 from the path of water within aqueduct 610.

In yet another example, support 650 may have water opening 682 in the water chamber 656. The path of water may extend from the plate 620 through water opening 682 when the water chamber 656 is positioned within aqueduct 610. A filter (not shown) may be positionable within water chamber 656. The path of water may extend from plate 620 through the water opening 682 to the terminating edge 690 of aqueduct 610.

In still another example, a shield 652 may be positionable within the aqueduct. Shield 652 may be positioned to obstruct a light path to the light source 670. Support 650 may also include shield 652 positionable over light source 670. Shield 652 may have a light, colored, or reflective surface positioned to direct a quantity of light to the path of water. Shield 652 may be positioned to prevent visual or physical contact with the light source 670 through aqueduct 610 by blocking a visual path from a user to the light source 670 or a physical path to light source 670. For instance, shield 652 may be angled or curved toward a central portion of aqueduct 610 when positioned within aqueduct 610. Blocking the visual path may provide illumination without a user directly viewing the light source 670, which may provide advantages to aesthetic impact of device 600. Physically blocking the path to the light source 670 may also enhance safety by preventing a user such as a small child from reaching into the scupper aqueduct 610 and touching the light source 670, which may prevent an electrical burn or thermal burn.

In another example, shield 652 may be connected to the support.

The design of FIGS. 11-17 may include any of the other features discussed relative to FIGS. 2A-10, all of which are considered within the scope of the present disclosure.

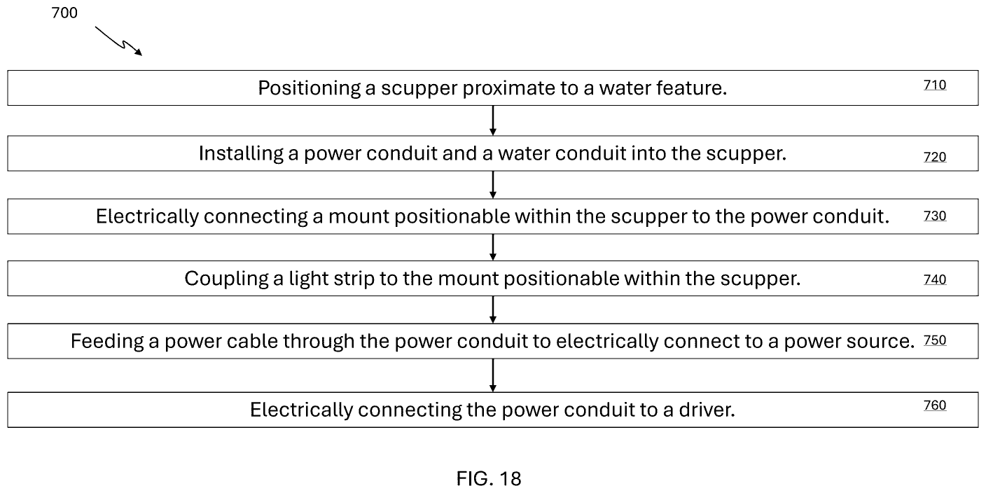

FIG. 18 illustrates a method 700 of lighting a pool water scupper, in accordance with an example of the present disclosure. It should be noted that any process descriptions or blocks in flow charts should be understood as representing modules, segments, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

A method of lighting a water scupper system may include the steps of positioning a scupper proximate to a water feature 710; installing a power conduit and a water conduit into the scupper 720; coupling a light strip to a mount positionable in the scupper 740; electrically connecting the mount positionable within the scupper to the power conduit 730; feeding a power cable through the power conduit to electrically connect to a power source 750; and electrically connecting the power conduit to a driver 760.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A pool water scupper lighting system comprising:
a scupper body;
a waterspout extending from the scupper body; and
at least one light source positioned at least partially in the waterspout and located proximate to a path for water, wherein the at least one light source is positioned to direct a quantity of light into the path for water.

2. The pool water scupper lighting system of claim 1, further comprising a mount affixed within the scupper body and connectable between the scupper body and the at least one light source.

3. The pool water scupper lighting system of claim 2, further comprising a spout plug positioned proximate to an interface between the scupper body and the waterspout, wherein the mount extends through the spout plug.

4. The pool water scupper system of claim 1, further comprising a power source electrically connectable to the at least one light source, wherein the at least one light source is electrically isolated from the path for water.

5. The pool water scupper lighting system of claim 1, wherein the at least one light source is at least one of: a light pipe or an LED strip.

6. The pool water scupper lighting system of claim 1, further comprising a filter located within the scupper body, wherein a laminar flow of water extends from the filter along at least a portion of the path for water.

7. The pool water scupper lighting system of claim 1, further comprising a lighting system adapter coupled to the scupper body, wherein the lighting system adapter electrically isolates the power source from the path of water.

8. A lighting system for a pool scupper, comprising:
an aqueduct connectable to a water pipe adapter; and
at least one light source positioned at least partially within the aqueduct and located proximate to a path for water, wherein the path for water extends to a terminating edge of the aqueduct from the water pipe adapter, wherein the at least one light source is positioned to direct a quantity of light into the path for water.

9. The lighting system for a pool scupper of claim 8, further comprising a water filter positionable in-line between the water pipe adapter and the terminating edge of the aqueduct.

10. The lighting system for a pool scupper of claim 9, further comprising:
a plate connectable to the aqueduct, wherein a substantially watertight seal is formed when the plate is connected to the aqueduct; and
a filter box connectable to the plate, wherein the water filter is positionable within the filter box.

11. The lighting system for a pool scupper of claim 9, further comprising a ramp extending from the filter box to the terminating edge of the aqueduct.

12. The lighting system for a pool scupper of claim 8, wherein a lighting adapter is connectable to the at least one light source through the plate.

13. The lighting system for a pool scupper of claim 8, further comprising a light strip positioned proximate to a terminating edge of the aqueduct.

14. The lighting system for a pool scupper of claim 13, further comprising a lens positioned between the light strip and the path for water.

15. A device to light a pool water scupper comprising:
a lighting adapter electrically connectable to a light source;
a plate attachable to an aqueduct, wherein a water pipe adapter connects to the plate at a first location, and the lighting adapter connects to the plate at a second location;
a path for water extending from the plate through the aqueduct and over a terminating edge of the aqueduct; and
a support positionable within the aqueduct, wherein the support holds the light source along at least a portion of the path for water within the aqueduct.

16. The device of claim 15, further comprising a grounding device affixable to the plate and electrically connectable to the light source.

17. The device of claim 15, wherein the support is slidably receivable by the plate.

18. The device of claim 15, wherein the support further comprises:
a light chamber and a water chamber, wherein the light chamber extends from the plate into the aqueduct; and
a water opening in the water chamber, wherein the path for water extends from the plate through the water opening when the water chamber is positioned within the aqueduct.

19. The device of claim 15, further comprising a shield positionable within the aqueduct, wherein the shield is positioned to at least partially obstruct a light path to the light source.

20. The device of claim 19, wherein the shield is connected to the support.
